(19) United States
(12) Patent Application Publication
(10) Pub. No.: US 2024/0421989 A1
(43) Pub. Date: Dec. 19, 2024

(54) DOUBLE-LAYER ENCRYPTION FOR WIRELESS COMMUNICATION SYSTEMS

(71) Applicants: University of Kansas, Lawrence, KS (US); Wichita State University, Wichita, KS (US)

(72) Inventors: Hyuck M. Kwon, Wichita, KS (US); Rémi A. Chou, Wichita, KS (US); Richard Lahman, Wichita, KS (US); Taejoon Kim, Lawrence, KS (US)

(73) Assignees: University of Kansas, Lawrence, KS (US); Wichita State University, Wichita, KS (US)

(21) Appl. No.: 18/747,127

(22) Filed: Jun. 18, 2024

Related U.S. Application Data
(60) Provisional application No. 63/521,812, filed on Jun. 19, 2023.

(51) Int. Cl. H04L 9/08

(52) U.S. Cl. CPC H04L 9/088

(57) ABSTRACT

Described herein is a method. The method may include receiving, by a first device, data of a first layer of the first device, the data for transmission over a network to a second device. The method may include encrypting, by the first device, the data at the first layer, to generate first encrypted data. The method may include encrypting, by the first device, the first encrypted data at a second layer, to generate second encrypted data. The method may include transmitting, by the first device, the second encrypted data via the network to the second device.

### CROSS-REFERENCE TO RELATED APPLICATIONS

This application claims the benefit of and priority to U.S. Provisional Patent Application No. 63/521,812 filed Jun. 19, 2023, which is incorporated by reference herein in its entirety for any and all purposes.

### STATEMENT OF U.S. GOVERNMENT SUPPORT

This invention was made with government support under 2226447 and 2335455 awarded by the National Science Foundation. The government has certain rights in the invention.

### BACKGROUND

The present disclosure relates generally to the field of wireless technology which allows user devices to communicate with one another over a network. Data can be transmitted between devices over a network via radio waves of different frequencies. Some user devices may employ or provide various security measures, such as encryption, to secure or protect such data transmissions over the network.

### SUMMARY

Systems, methods, and computer readable medium for performing double-layer encryption for various wireless communication systems.

In one aspect, this disclosure is directed to a method. The method may include receiving, by a first device, data of a first layer of the first device, the data for transmission over a network to a second device. The method may include encrypting, by the first device, the data at the first layer, to generate first encrypted data. The method may include encrypting, by the first device, the first encrypted data at a second layer, to generate second encrypted data. The method may include transmitting, by the first device, the second encrypted data via the network to the second device.

In some embodiments, the first layer includes an application layer, and the second layer includes a physical layer. In some embodiments, encrypting the data at the first layer includes encrypting, by the first device, via a secret key, the data at the first layer, to generate the first encrypted data. In some embodiments, the method includes transmitting, by the first device, the secret key to the second device. The second device may receive the second encrypted data and decrypt a decrypted version of the second encrypted data using the secret key. In some embodiments, transmitting the secret key is performed at a first geographic location. The method may include establishing, by the first device, a connection with the network at a second geographic location, the first device encrypting the data of the first layer responsive to establishing the connection with the network. In some embodiments, a length of the secret key is set according to a security threshold of the network. In some embodiments, encrypting the data at the first layer may include performing an exclusive OR operation using the secret key and the data of the first layer. In some embodiments, encrypting the data at the first layer is performed prior to performing a channel forward error correction encoding.

In another aspect, this disclosure is directed to a method. The method may include receiving, by a first device via a network from a second device, encrypted data. The method may include decrypting, by the first device, the encrypted data at a first layer of the first device, to generate first decrypted data. The method may include decrypting, by the first device, the first decrypted data at a second layer of the first device, to generate second decrypted data. The method may include providing, by the first device, the second decrypted data to an application at the second layer.

In some embodiments, the first layer includes a physical layer, and the second layer includes an application layer. In some embodiments, decrypting the data at the second layer includes decrypting, by the first device, via a secret key, the first decrypted data, to generate the second decrypted data. In some embodiments, the method includes receiving, by the first device, the secret key from the second device. The second device may encrypt data using the secret key to generate first encrypted data and encrypt the first encrypted data to generate second encrypted data for transmission via the network to the first device. In some embodiments, receiving the secret key is performed at a first geographic location. The method may include establishing, by the first device, a connection with the network at a second geographic location, the first device decrypting the data of the first layer responsive to establishing the connection with the network. In some embodiments, decrypting the data at the second layer includes performing an exclusive OR operation using the secret key and the first decrypted data. In some embodiments, decrypting the data at the second layer is performed after performing a channel forward error correction decoding.

In another aspect, this disclosure is directed to a system. The system may include a first device with one or more processors, the one or more processors may be configured to: receive data of a first layer of the first device, the data for transmission over a network to a second device, encrypt the data at the first layer, to generate first encrypted data, encrypt the first encrypted data at a second layer, to generate second encrypted data, and transmit the second encrypted data via the network to the second device.

In some embodiments, the first layer includes a physical layer, and the second layer includes an application layer. In some embodiments, encrypting the data at the first layer includes encrypting, via a secret key, the data at the first layer, to generate the first encrypted data. In some embodiments, encrypting the data at the first layer may include encrypting, via a secret key, the data at the first layer, to generate the first encrypted data. In some embodiments, the one or more processors are further configured to transmit the secret key to the second device, the second device receiving the second encrypted data, and decrypting a decrypted version of the second encrypted data using the secret key. In some embodiments, transmitting the secret key is performed at a first geographic location. The one or more processors may be further configured to establish a connection with the network at a second geographic location, where encrypting the data of the first layer is responsive to establishing the connection with the network.

### BRIEF DESCRIPTION OF THE DRAWINGS

FIG. 1. is a block diagram of a system for double-layer encryption and decryption of data transmitted between devices over a network, according to an example implementation of the present disclosure.

FIG. 2. is a graph of an example comparison of bit error rate (BER) and signal-to-noise ratio (SNR) in dB, for three devices including a control device and two receiving devices of the system of FIG. 1, according to an example implementation of the present disclosure.

FIG. 3. is a flowchart showing an example method for double-layer encryption and decryption of data transmitted between devices over a network, according to an example implementation of the present disclosure.

FIG. 4 is a block diagram of system illustrating the steps of double-layer encryption process between two users, according to an example implementation of the present disclosure.

FIG. 5A and FIG. 5B are diagrams illustrating at least one of the technical effects of utilizing double layer encryption, according to an example implementation of the present disclosure.

### DETAILED DESCRIPTION

The systems and methods described herein relate to double layer encryption (DLE), which involves multiple layer encryption to protect data between users. According to the systems and methods described herein, data transmitted by a device may be performed at an application layer and at a physical layer. For example, an outer layer encryption may be completed by a customer at an application layer of the device (e.g., via 5G phone application layer, whereas the inner layer encryption may be completed by a phone manufacturer, system operator, or any third party.

DLE solves various technical problems within the current wireless system market, as third parties carry uncertainty in regard to the level of security their current systems hold. Any inner encryption executed/implemented/provided by a third party, i.e., any 5G operator, between a transmitter (TX) and a receiver (RX) may be zero trust. For example, the third party which provides the inner layer encryption can eavesdrop on data communicated between a TX and RX, which rises concerns of consumer privacy. DLE is unique as it provides a common encryption to be shared by only the TX and RX prior to communications, barring the need of a third party. The exclusive-or-addition (XOR) operation, e.g., a binary addition with a random key bit stream, is performed on each message bit. The DLE can be or include an application installed/deployed by a customer at the application layer (e.g., via an application executing on the device). The customer also has the option to encrypt his/her entire or partial message.

The systems and methods described herein may provide for more secure and faster wireless communication. A third party may be incapable of decrypting an intercepted message (e.g., even with a quantum computer) due to the XOR operation (e.g., a binary addition with a random key bit stream is performed on each message bit). Additionally, Standard Advanced Encryption Standard (AES) 256 implementation takes longer time to encrypt than the DLE scheme described herein. For a Standard AES 256 implementation, a parallel processing is used and takes about 1.3*2³⁰ cycles to encrypt 1 GB when the central processing unit (CPU) is working at 2.2 GHz or 2.2*10⁹ cycles. In other words, it takes 1.3*2³⁰/2.2*10⁹=0.634 seconds. However, the latency caused by the embodiments of the DLE with XOR operation is less than maximum 1 cycle per XOR operation. In other words, it takes 2³⁰ cycles to encrypt 1 GB in 2³⁰/2.2*10⁹=0.488 seconds, or an about 30% improvement. Further, the DLE implementation uses a simple serial processing in the latency computation, as opposed to the parallel processing as the standard AES 265. Additional improvements and technical benefits of the systems and methods are described in greater detail below.

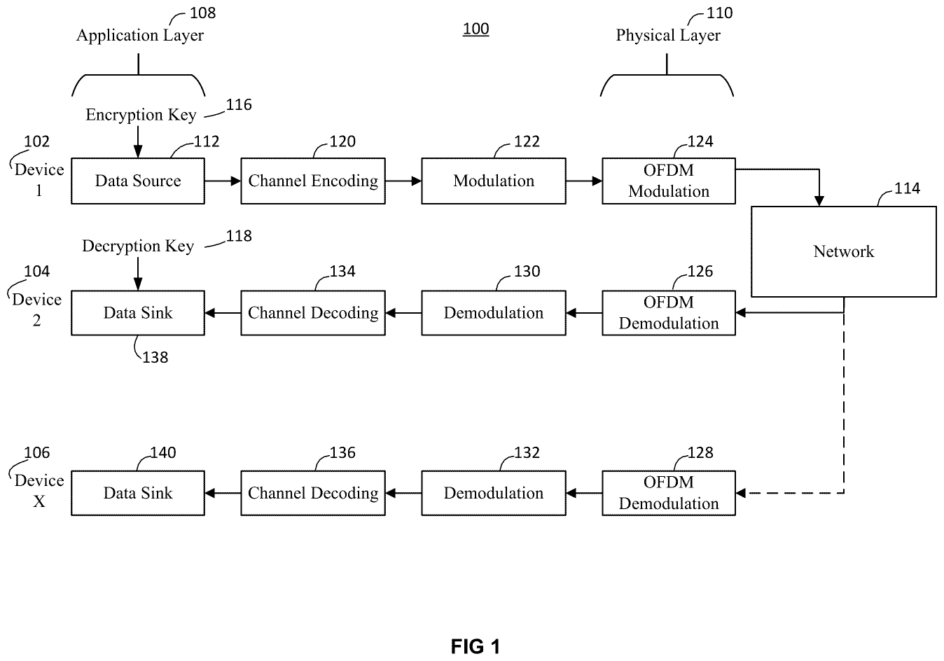

Referring generally to FIG. 1, depicted is a system 100 for double-layer encryption and decryption of data transmitted between devices over a network. As shown, the system 100 includes a transmitting (TX) device 102, and any number of possible receiving (RX) devices, including a target or targeted RX device 104 and an untrusted receiving (RX-U) device 106. The devices 102, 104, 106 may include any number of processors, Random-access Memory (RAM), storage units, transmitters, receivers, antennas, and/or any other software and hardware components. In various embodiments, the devices 102, 104, 106 may include components, elements, or hardware and software stack(s) which are defined or configured according to an open systems interconnection (OSI) model and/or a transmission control protocol/internet protocol (TCP/IP) model. Each of these models may include various layers used for communication and data transmission. An OSI Model may include, for example, an application layer, a presentation layer, a session layer, a transport layer, a network layer, a data link layer, and a physical layer. A TCP/IP Model may include, for example, an application layer, a transport layer, an internet layer, and a network access layer. As shown in FIG. 1, the devices 102, 104, 106 may include an application layer 108, a physical layer 110, and any number of additional layers mentioned above. In some embodiments, the physical layer 110 may be a layer of the transmitting device 102. In some embodiments, additional devices may have a physical layer 110, which may be configured to encrypt data for transmission over a medium. For example, the additional devices may include network nodes (e.g., base stations), intermediary devices (e.g., routers, relays, etc.). Such devices may be configured to perform encryption of data for transmission between endpoints (e.g., from the transmitting device 102 to the receiving device 104).

The transmitting device 102 may include a data source 112. The data source 112 may be configured to receive data of a first layer of the device 102. The first layer of the transmitting device 102 may be the application layer 108 in which data from any application executing or otherwise running on the transmitting device 102 is generated. Thus, the data source 112 may be or may include a data source of the device 102 which is generated for transmission over a network 114. As shown, the data received by the data source 112 of the transmitting device 102 may be for transmission to any number of receiving devices 104, 106 over a network 114. As shown in FIG. 1 and described in greater detail below, the transmitting device 102 may perform two encryptions on the data. The transmitting device 102 may perform an encryption at the application layer using a secret key 116, which may also be used by the targeted receiving device 104 for decryption as described in greater detail below.

In a trusted first geographic location, the transmitting device 102 and targeted receiving device 104 may share, exchange, or otherwise provide the secret key 116, 118. In some embodiments, the transmitting device 102 may generate and transmit the secret key 116 to the receiving device 104. In some embodiments, the receiving device 104 may generate and transmit the secret key 118 to the transmitting device 102. The devices 102, 104 may exchange the secret keys 116, 118 such that both devices 102, 104 have access to respective copies of the secret key 116, 118. The devices 102, 104 may be configured to share or exchange the secret key 116, 118 via a direct link (e.g., a wired connection between the devices), via a local network, via a secured network, etc. The first geographic location may be, for example, a location which is secure relative to a location of the network 114. For example, the first geographic location may be a military base, an ally territory, etc. The second geographic location may be an unsecure, untrusted, hostile, etc. area in which certain networks may be susceptible to interception or eavesdropping (e.g., by various third parties), or otherwise unsecure. The secret key 116 may be used for encrypting data to be transmitted from the transmitting device 102 to the targeted receiving device 104 over a network 114 associated with the second geographic location (e.g., that may be untrusted). The network may be an untrusted 5G network including but not limited to a base (e.g., a military base) in an international enemy battlefield. The same secret key 118 may also be used for decrypting the data received by the targeted receiving device 104. In some embodiments, the devices 102, 104 may set, define, or otherwise establish a length of the secret key 116, 118 according to a security threshold of the network 114. For example, the security threshold may be associated with particular trust levels associated with different geographic locations. Users of the devices 102, 104 may select the trust level for the second geographic location, and the devices 102, 104 may establish the length of the secret key according to the associated trust level selected by the users.

The transmitting device 102 may perform a first encryption of the data (e.g., from the data source) at the application layer 108 to generate the first encrypted data. In some embodiments, the transmitting device 102 may generate the first encrypted data at the application layer by performing an XOR operation using the secret key 116 and the data of the first layer of the device 102. As shown, the transmitting device 102 may perform forward error correction (FEC) encoding 120 on the first encrypted data, to detect and correct transmission errors. Additionally, the transmitting device 102 may be configured to modulate 122 the encrypted and encoded data (e.g., using orthogonal frequency-division multiplexing (OFDM) modulation 124). Then, at the physical layer 110, the transmitting device 102 may perform a second encryption to generate a second encrypted data. In various embodiments, while described as performing the second encryption at the physical layer 110 of the transmitting device 102, the second encryption may be performed at an intermediary or third-party device 106 (e.g., at the physical layer 110 of the third-party device 106 or at another/different layer of the third-party device 106). The second encryption at the physical layer 110 may be an encryption at the physical layer 110 which may be separate from the encryption at the application layer 108. Once the second encrypted data is generated, the transmitting device 102 may be configured to transmit the second encrypted data (e.g., via the untrusted network 114 using a transmitter or antenna of the transmitting device 102) to the receiving device 104.

In various instances, due to the network 114 being untrusted, the second encrypted data may be received by any number of devices including the targeted receiving device 104 or an untrusted receiving device 106. In both cases, the devices 104, 106 may perform a first decryption at the physical layer 110 during OFDM demodulation 126, 128 which may generate the first decrypted data. Then, the receiving device 104, 106 which performs decryption at the physical layer, may perform demodulation 130, 132 and FEC channel decoding 134, 136 following decryption. In some embodiments, only the targeted receiving device 104 may be configured to perform a second decryption at the application layer 108 because this device has been given the secret key 118 (e.g., whereas the untrusted receiving device 106 does not possess the secret key 118). This second decryption in the targeted receiving device 104 may generate second decrypted data by performing an XOR operation using both the previously shared and known secret key 118 and the first decrypted data. The decrypted data may be received in a data sink 138 and may be routed to any application being executed or ran on the receiving device 106 which corresponds to the data. For example, the applications may be communication applications, geolocation tracking applications, etc. which are used for communicating by users of the respective devices 102, 104. Because the untrusted receiving device 106 does not have the secret key 118, the device may not be capable of performing the second decryption and instead will produce a high bit error rate (BER) at FEC channel decoding 136. Thus, the untrusted receiving device 106 may not receive accurate data in a data sink 140 and thus may not accurately intercept and decipher the data.

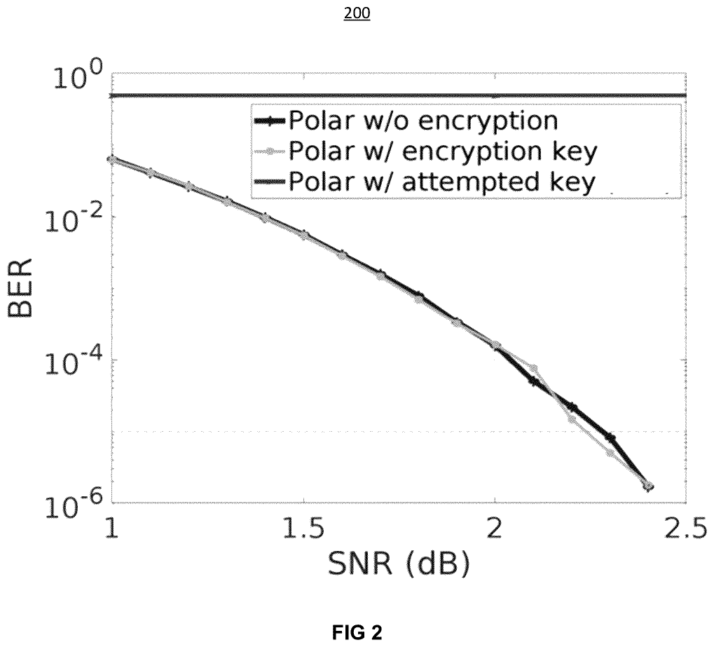

Referring generally to FIG. 2, depicted is a graph 200 comparing bit error rate (BER) to the signal-to-noise ratio (SNR) for three different receiving devices. These devices include a control receiving device that is receiving data without double-layer encryption (Polar without encryption), the targeted receiving device with the secret key that is receiving encrypted data (Polar with encryption), and the untrusted receiving device without the secret key that is also receiving encrypted data (Polar without secret key). The simulation may employ polar forward error correction (FEC), which may be used in various wireless cellular network (such as 5G networks), with codeword length N=1024 bits and message block length K=512 bits. Polar coding may include a method of sorting channels into bit-channels based on reliability, where data may be transmitted on bit-channels computed to be reliable. A normal operation of wireless communication may involve a SNR greater than 2.3 dB. As shown in FIG. 2, the targeted receiving device may maintain a low BER of less than 10⁻⁵ when the SNR is greater than 2.3 dB whereas the untrusted receiving device has a relatively constant BER of 0.5 at an SNR greater than 2.3 dB. As compared to the control receiving device, the targeted receiving device may not experience BER degradation.

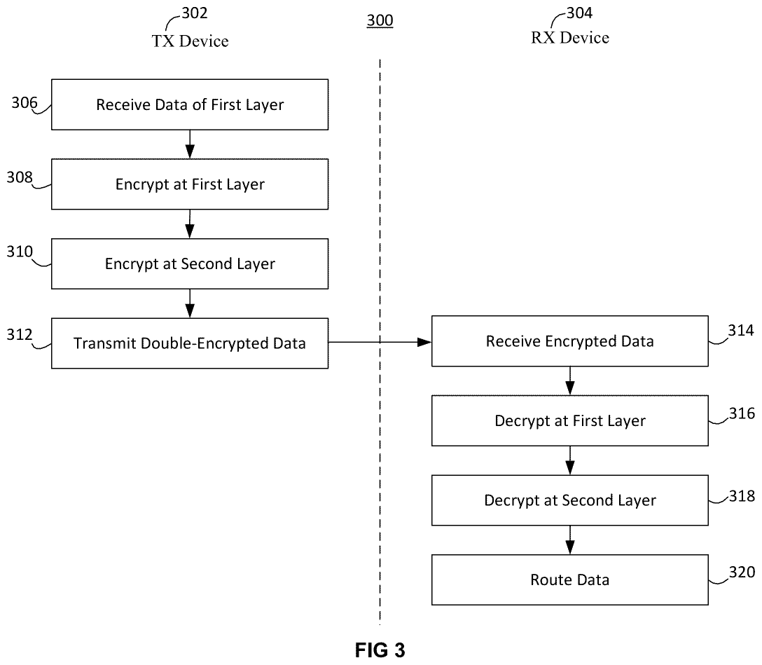

Referring generally to FIG. 3, depicted is a flowchart 300 illustrating the steps of double-layer encryption of data at TX Device, a transmitting device 302, transmission of the data over a network, and decryption of the data at RX Device (e.g., a targeted receiving device 304). At step 306, as shown in FIG. 3, the transmitting device 302 may receive data of a first layer of the device. At step 308, the transmitting device 302 encrypts the data at the first layer. The first layer may include an application layer. The first encryption is completed through an XOR operation using the shared secret key and the received data of the first layer. This encryption generates first encrypted data. At step 310, the transmitting device 302 encrypts the first encrypted data at a second layer. The second layer may include a physical layer. The second encryption generates second encrypted data. At step 312, the second encrypted data is then transmitted to the targeted receiving device 304 over the network. At step 314, the second encrypted data is then received by the targeted receiving device 304. At step 316, the targeted receiving device 304 decrypts the received second encrypted data at a first layer. The first layer may include a physical layer. This first decryption generates the first decrypted data. At step 318, the targeted receiving device 304 performs a decryption of the first decrypted data at a second layer. The second layer may include an application layer. The second decryption is completed through an XOR operation using the shared secret key and the first decrypted data. This second decryption generates second decrypted data. At step 320, the data is routed to an application of the targeted receiving device 304.

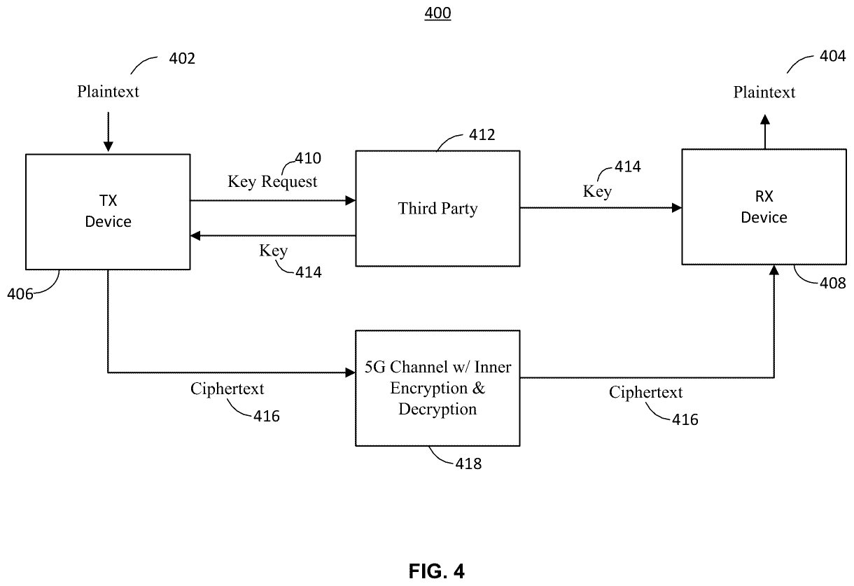

Referring generally to FIG. 4, depicted is a block diagram illustrating the steps of double-layer encryption process between two users. Plaintext 402 at a transmitter device 406 can be delivered as plaintext 404 at a receiver device 408, following double encryption and decryption. Prior to transmission of data, the TX device 406 may make a key request 410 to a third party (e.g., third party service or resource) 412 providing DLE services to form a first layer of encryption on both devices. The third party 412 then delivers a unique and confidential key 414 to both the TX device 406 and the RX device 408. The TX device 406 may be configured to use the shared secret key 414 to encrypt the plaintext 402 at the first layer. The first encryption may be completed through an XOR operation using the shared secret key 414 and plaintext 402 of the first layer. This encryption generates first encrypted data. The TX device 406 then encrypts the first encrypted data at a second layer (e.g., at the physical layer). The second encryption generates second encrypted data to form ciphertext 416, secured by DLE. As shown, the ciphertext 416 may then be transmitted to the RX device 408 over a wireless medium (e.g., a 5G channel) with inner encryption and decryption capabilities 418. Then, once received by the RX device 408, decryption of the first decrypted data at a second layer occurs. The second decryption follows using the shared secret key 414 and the first decrypted data to allow the plaintext 404 to be received.

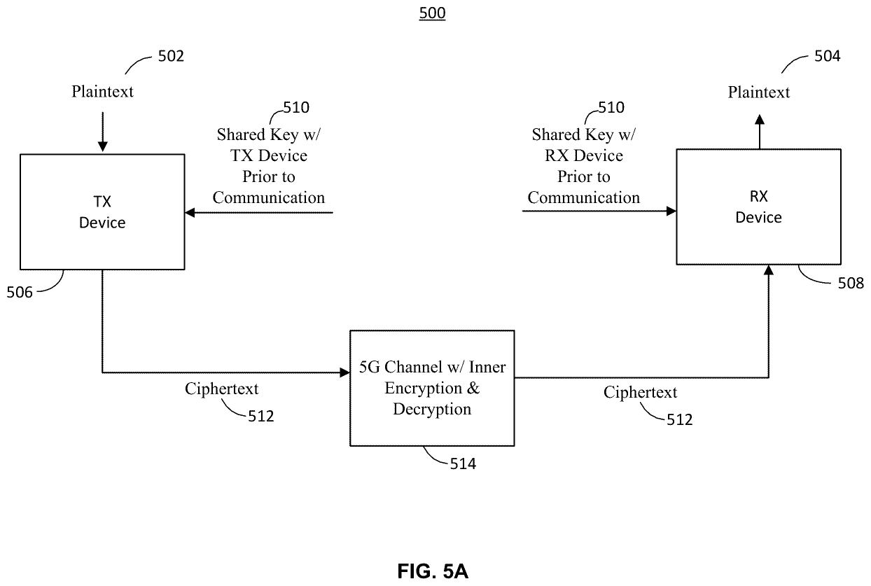

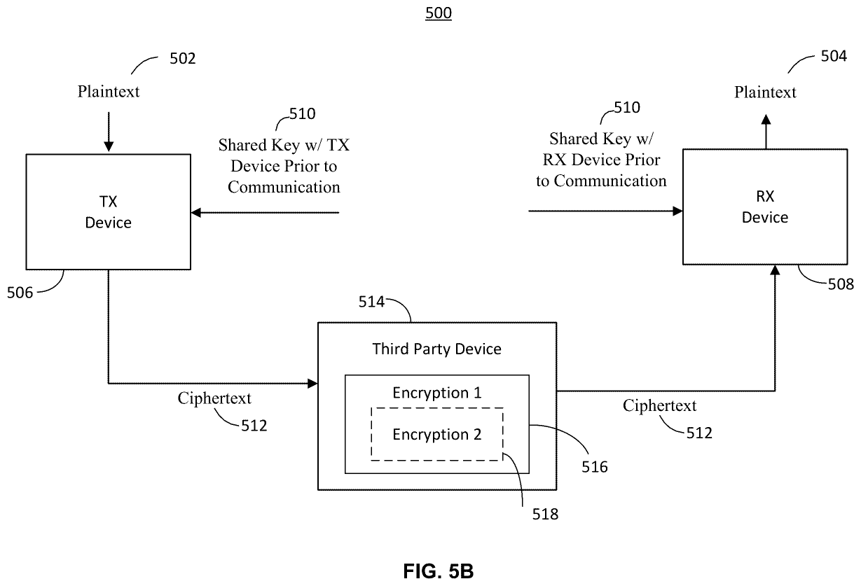

Referring generally to FIG. 5A and FIG. 5B, depicted are diagrams illustrating at least some of the technical effects of utilizing double layer encryption to secure plaintext from a TX Device 502 transmitted to plaintext on an RX Device 504. In FIG. 5A, a secret shared key 510 is disclosed to the TX device, the TX Device 506 and to the RX Device 508, to create a first layer of encryption for the plaintext at the TX device 502 prior the second layer of encryption performed by the TX device 506. The ciphertext 512 secured by DLE may then be transmitted over the 5G channel with inner encryption and decryption capabilities 514, where decryption can proceed by the RX device using the shared secret key to reveal the plaintext 504. In FIG. 5B, the ciphertext 512 can remain secure, as the third party device on the wireless channel 514 may be unable to fully decrypt the data. Because the third party 514 does not have record of the shared secret key 510 between the TX device 506 and the RX device 508, the second layer of encryption 518 can be decrypted, but the first layer 516 remains encrypted. As a result, data between the TX device 506 and the RX device 508 remains secure, regardless of the geolocation in which data is exchanged between the devices 506, 508.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:

A. A method comprising:
receiving, by a first device, data of a first layer of the first device, the data for transmission over a network to a second device;
encrypting, by the first device, the data at the first layer, to generate first encrypted data;
encrypting, by the first device, the first encrypted data at a second layer, to generate second encrypted data; and
transmitting, by the first device, the second encrypted data via the network to the second device.

B. The method of paragraph A, wherein the first layer comprises an application layer, and the second layer comprises a physical layer.

C. The method of paragraph A or B, wherein encrypting the data at the first layer comprises encrypting, by the first device, via a secret key, the data at the first layer, to generate the first encrypted data.

D. The method of any of paragraphs A-C, further comprising transmitting, by the first device, the secret key to the second device, the second device receiving the second encrypted data, and decrypting a decrypted version of the second encrypted data using the secret key.

E. The method of any of paragraphs A-D, wherein transmitting the secret key is performed at a first geographic location, the method further comprising:

establishing, by the first device, a connection with the network at a second geographic location, the first device encrypting the data of the first layer responsive to establishing the connection with the network.

F. The method of any of paragraphs A-E, wherein a length of the secret key is set according to a security threshold of the network.

G. The method of any of paragraphs A-F, wherein encrypting the data at the first layer comprises performing an exclusive OR operation using the secret key and the data of the first layer.

H. The method of any of paragraphs A-G, wherein encrypting the data at the first layer is performed prior to performing a channel forward error correction encoding.

I. A method comprising:
receiving, by a first device via a network from a second device, encrypted data;
decrypting, by the first device, the encrypted data, to generate first decrypted data;
decrypting, by the first device, the first decrypted data, to generate second decrypted data; and
   providing, by the first device, the second decrypted data to an application at the second layer.

J. The method of paragraph I, wherein the encrypted data is encrypted at a first layer and a second layer of the second device.

K. The method of paragraph I or J, wherein the first layer comprises a physical layer, and the second layer comprises an application layer.

L. The method of any of paragraphs I-K, wherein decrypting the data at the second layer comprises decrypting, by the first device, via a secret key, the first decrypted data, to generate the second decrypted data.

M. The method of any of paragraphs I-L, further comprising receiving, by the first device, the secret key from the second device, the second device encrypting data using the secret key to generate first encrypted data, and encrypting the first encrypted data to generate second encrypted data for transmission via the network to the first device.

N. The method of any of paragraphs I-M, wherein receiving the secret key is performed at a first geographic location, the method further comprising:
establishing, by the first device, a connection with the network at a second geographic location, the first device decrypting the data of the first layer responsive to establishing the connection with the network.

O. The method of any of paragraphs I-N, wherein decrypting the first decrypted data to generate the second decrypted data comprises performing an exclusive OR operation using the secret key and the first decrypted data.

P. The method of any of paragraphs I-O, wherein decrypting the first decrypted data is performed after performing a channel forward error correction decoding.

Q. A system, comprising:
a first device comprising one or more processors, the one or more processors configured to:
   receive data of a first layer of the first device, the data for transmission over a network to a second device;
   encrypt the data at the first layer, to generate first encrypted data;
   encrypt the first encrypted data at a second layer, to generate second encrypted data; and
   transmit the second encrypted data via the network to the second device.

R. The system of paragraph Q, wherein the first layer comprises an application layer, and the second layer comprises a physical layer.

S. The system of paragraph Q or R, wherein encrypting the data at the first layer comprises encrypting, via a secret key, the data at the first layer, to generate the first encrypted data.

T. The system of any of paragraphs I-S, wherein transmitting the secret key is performed at a first geographic location, wherein the one or more processors are further configured to:
establish a connection with the network at a second geographic location;
encrypt the first encrypted data at the second geographic location, to generate second encrypted data; and
transmit the second encrypted data at the second geographic location to the second device, the second device decrypting the second encrypted data using the secret key received at the first geographic location.

Other embodiments are set forth in the following claims, along with the full scope of equivalents to which such claims are entitled.

What is claimed is:

1. A method comprising:
receiving, by a first device, data of a first layer of the first device, the data for transmission over a network to a second device;
encrypting, by the first device, the data at the first layer, to generate first encrypted data;
encrypting, by the first device, the first encrypted data at a second layer, to generate second encrypted data; and
transmitting, by the first device, the second encrypted data via the network to the second device.

2. The method of claim 1, wherein the first layer comprises an application layer, and the second layer comprises a physical layer.

3. The method of claim 1, wherein encrypting the data at the first layer comprises encrypting, by the first device, via a secret key, the data at the first layer, to generate the first encrypted data.

4. The method of claim 3, further comprising transmitting, by the first device, the secret key to the second device, the second device receiving the second encrypted data, and decrypting a decrypted version of the second encrypted data using the secret key.

5. The method of claim 4, wherein transmitting the secret key is performed at a first geographic location, the method further comprising:
establishing, by the first device, a connection with the network at a second geographic location, the first device encrypting the data of the first layer responsive to establishing the connection with the network.

6. The method of claim 3, wherein a length of the secret key is set according to a security threshold of the network.

7. The method of claim 3, wherein encrypting the data at the first layer comprises performing an exclusive OR operation using the secret key and the data of the first layer.

8. The method of claim 1, wherein encrypting the data at the first layer is performed prior to performing a channel forward error correction encoding.

9. A method comprising:
receiving, by a first device via a network from a second device, encrypted data;
decrypting, by the first device, the encrypted data, to generate first decrypted data;
decrypting, by the first device, the first decrypted data, to generate second decrypted data; and
providing, by the first device, the second decrypted data to an application at the second layer.

10. The method of claim 9, wherein the encrypted data is encrypted at a first layer and a second layer of the second device.

11. The method of claim 10, wherein the first layer comprises a physical layer, and the second layer comprises an application layer.

12. The method of claim 9, wherein decrypting the data at the second layer comprises decrypting, by the first device, via a secret key, the first decrypted data, to generate the second decrypted data.

13. The method of claim 12, further comprising receiving, by the first device, the secret key from the second device, the second device encrypting data using the secret key to generate first encrypted data, and encrypting the first encrypted data to generate second encrypted data for transmission via the network to the first device.

14. The method of claim 13, wherein receiving the secret key is performed at a first geographic location, the method further comprising:
establishing, by the first device, a connection with the network at a second geographic location, the first device decrypting the data of the first layer responsive to establishing the connection with the network.

15. The method of claim 12, wherein decrypting the first decrypted data to generate the second decrypted data comprises performing an exclusive OR operation using the secret key and the first decrypted data.

16. The method of claim 15, wherein decrypting the first decrypted data is performed after performing a channel forward error correction decoding.

17. A system, comprising:
a first device comprising one or more processors, the one or more processors configured to:
receive data of a first layer of the first device, the data for transmission over a network to a second device;
encrypt the data at the first layer, to generate first encrypted data;
encrypt the first encrypted data at a second layer, to generate second encrypted data; and
transmit the second encrypted data via the network to the second device.

18. The system of claim 17, wherein the first layer comprises an application layer, and the second layer comprises a physical layer.

19. The system of claim 16, wherein encrypting the data at the first layer comprises encrypting, via a secret key, the data at the first layer, to generate the first encrypted data.

20. The system of claim 19, wherein transmitting the secret key is performed at a first geographic location, wherein the one or more processors are further configured to:
establish a connection with the network at a second geographic location;
encrypt the first encrypted data at the second geographic location, to generate second encrypted data; and
transmit the second encrypted data at the second geographic location to the second device, the second device decrypting the second encrypted data using the secret key received at the first geographic location.
